(19) United States
(12) Patent Application Publication
(10) Pub. No.: US 2008/0034914 A1
(43) Pub. Date: Feb. 14, 2008

(54) PRESENTABLE PARKING BRAKE RELEASE LEVER

(75) Inventor: John Hwang, Columbus, OH (US)

Correspondence Address: RANKIN, HILL, PORTER & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 11/463,178

(22) Filed: Aug. 8, 2006

(51) Int. Cl. G05G 5/06

(52) U.S. Cl. 74/529

(57) ABSTRACT

A parking brake control system for a vehicle has a pedal and a brake release handle that are operatively connected to one another by a linkage. The pedal has an arm and a pedal pad. An operator depresses the pedal to simultaneously engage a parking brake and cause the release handle to move from a position generally flush with an instrument panel, to a position extending from the instrument panel. The parking brake is disengaged by pulling the release handle farther out of the instrument panel, and then releasing the handle to permit the handle to return to its generally flush condition while allowing the pedal to move to an undepressed position.

### BACKGROUND OF THE INVENTION

1. Field of the Invention

The present invention is directed toward a parking brake apparatus for a vehicle and a method for operating the parking brake apparatus.

2. Description of Related Art

In braking systems for vehicles, it is common to have a parking brake. The parking brake is a supplementary brake that can be used if the vehicle's primary brake system has a failure. In addition, the parking brake can be used to keep the vehicle motionless when parked.

The parking brake usually has a cable with a first end and a second end. The first end is connected to an actuator and the second end is attached to a brake apparatus. The actuator, often a foot-operated pedal, is manipulated by an operator to initiate engagement of the brake apparatus. The pedal can be located below an instrument panel of the vehicle. The parking brake apparatus can either be a standalone assembly that prevents the vehicle from moving or can work in unison with the primary brake system.

To engage the parking brake apparatus, an operator depresses the pedal toward the vehicle floor. Most parking brake control systems have a ratchet locking mechanism that will keep the parking brake apparatus engaged after the pedal is depressed. When the operator desires to move the vehicle, a release lever must be actuated. The release lever includes a handle that must be pulled. The handle is typically part of the instrument panel and the handle is usually located in a lower portion of the instrument panel. Pulling the release handle disengages the parking brake apparatus, returns the pedal to a normal or disengaged position, and allows the vehicle to be moved.

There are two typical arrangements for parking brake control systems (i.e. the brake pedal and brake release handle). In the first arrangement, the release handle is always flush with the instrument panel. Unfortunately, in this arrangement, there is no visual/tactile feedback provided to the operator indicating whether the parking brake is engaged or disengaged. The second arrangement is one in which the release handle projects from the instrument panel a fixed amount. Thus, even when the parking brake control system is disengaged, the release handle projects from the instrument panel. Unfortunately, this arrangement also lacks visual/tactile indication to the operator of the state of the parking brake, is unsightly and a potential catch hazard when the operator is entering or exiting the vehicle. Therefore, there exists a need in the art for a parking brake control system including a parking brake pedal and a release handle that is safe to use and provides visual and tactile feedback to the operator indicating the status of the parking brake.

### SUMMARY OF THE INVENTION

The present invention is directed toward a parking brake control system that is safe to use, and that provides distinct tactile and visual indication to the operator of the parking brake status (engaged/disengaged). In accordance with the present invention, the parking brake control system includes a parking brake pedal and a brake release handle that are operatively interconnected by a linkage.

In further accordance with the present invention, the brake release handle is flush with the instrument panel when the parking brake is disengaged, and projects from the instrument panel when the parking brake is engaged, thereby providing visual/tactile feedback to the operator. With the present invention, the user is provided with a visual indication of the status of the system that clearly shows whether the brake is engaged or disengaged. Also, as the user can feel the intersection surface of the instrument panel and the release handle, the control system of the present invention provides tactile indication of the parking brake status to the user. The user can thus ascertain the status of the system even in low level light situations.

### BRIEF DESCRIPTION OF THE DRAWINGS

These and further features of the invention will be apparent with reference to the following description and drawings, wherein:

FIG. 1 is a perspective view of the parking brake control system of the present invention when the parking brake is disengaged;

FIG. 2 is a perspective view of the of the control system, and schematically illustrates actuation of the control system to engage the parking brake;

FIG. 16 is a perspective view of the control system and schematically illustrates return of the control system to the normal position to disengage the parking brake; and,

FIG. 4 is a perspective view similar to FIG. 16, but with the parking brake control system returned to a rest or normal position following disengagement of the parking brake.

### DETAILED DESCRIPTION OF THE PREFERRED EMBODIMENTS

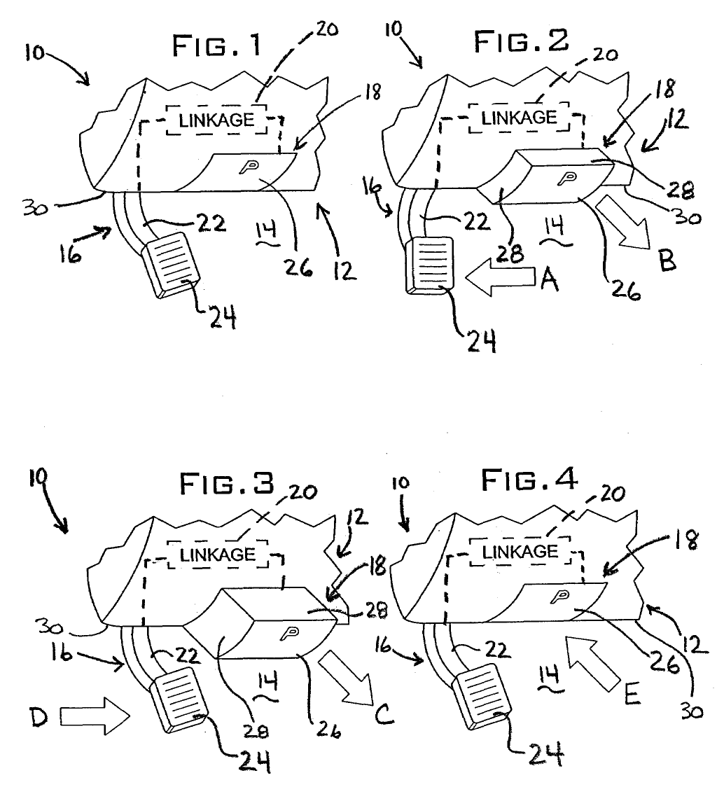

With reference to FIG. 1, a parking brake control system 10 is disposed on or adjacent an instrument panel 12, above a floor 14 in a vehicle. The parking brake control system 10 includes a brake pedal 16 and a brake release handle 18 that cooperate with a linkage 20 to engage/disengage a parking brake (not shown). The pedal 16 has an arm 22 with a pedal pad 24, while the release handle 18 has a front face 26 and sides 28.

It is considered apparent that those skilled in the art of parking brakes and parking brake control systems can envision numerous mechanical and/or electromechanical linkages that can be used interchangeably with the control system 10 of the present invention. Accordingly, the present invention is not limited to use of any particular linkage, and the linkage 20 is only shown schematically, and will not be described in detail hereinafter.

The pedal 16 is operatively connected to the release handle 18 via the linkage 20. Generally, as will be apparent from the following discussion, the linkage 20 connects the pedal 16 and release handle 18 such that, when the pedal 16 is depressed, the handle 18 is extended from the instrument panel 12 and such that when the pedal 16 is undepressed, the handle 18 is flush with the instrument panel 12.

The release handle 18 is located at a lower portion 30 of the instrument panel 12. The release handle 18 and the instrument panel 12 have a common angle or degree of curvature so there is a smooth transition between the handle 18 and instrument panel 12. Preferably, the pedal pad 24 has a nonskid surface to aid in proper engagement between the operator and the pedal 16. The arm 22 extends away from the pedal pad 24 and toward the instrument panel 12. After passing underneath the panel 12, the arm 22 of pedal 16 connects to the linkage 20 and the linkage 20, in turn, is then connected to the handle 18.

Operation of the parking brake control system 10 to engage/disengage the parking brake will now be discussed. The normal or rest position of the parking brake control system 10 corresponds with a disengaged parking brake. When the parking brake control system 10 is in the normal position, the parking brake is disengaged and the vehicle is free to move. On the other hand, when the parking brake control system 10 is in an actuated position, the parking brake is engaged and the vehicle is immobilized.

FIG. 1 illustrates the parking brake control system 10 in the normal or rest position. In this position, the front face 26 of the release handle 18 is flush with the instrument panel 12. FIG. 2 illustrates the parking brake control system 10 in the actuated position. Actuation occurs when an operator depresses the pedal pad 24 of the pedal 16 toward the floor 14. As is shown in FIG. 2, when the pedal 16 is depressed (Arrow A), the release handle 18 projects (Arrow B) from the instrument panel 12. The sides 28 of the release handle 18 then become visible and thus provide visual and tactile indication to the operator that the parking brake is engaged. For example, in low light situations the operator can merely feel around the release handle 18 to determine if the release handle 18 projects from the instrument panel 12. If the operator feels that the release handle 18 is projected from the instrument panel 12, the operator knows that the brake control system 10 is actuated and that the parking brake is engaged. Further, when favorable optical conditions exist inside of the vehicle, the operator can quickly observe the status of the system 10 by looking at the release handle 18 (i.e., whether the release handle 18 projects from the instrument panel 12).

When the operator wants to disengage the parking brake, the release handle 18 must be returned from the actuated position to the rest or normal position. In order to accomplish this task, as shown in FIG. 3, the release handle 18 is pulled away from the instrument panel 12, as shown by Arrow C, until a pre-set mechanical limit is reached. Then, the operator releases the handle 18 to allow the handle 18 to return to the normal position. As the handle 18 returns to the normal position, the pedal 16 will pivot toward the operator and away from the floor 14 as shown by Arrow D. At this point, the parking brake control system 10 is in the normal position, as shown in FIG. 4, and the parking brake is disengaged. Arrow E indicates that the handle 18 has returned to the normal position, flush with the instrument panel 12.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims. For example, it is contemplated that different shaped handles or different shaped pedals may be employed without departing from the scope and spirit of the present invention. Furthermore, while the release handle has been illustrated as being supported in the lower portion of the instrument panel, other locations on the instrument panel are possible and contemplated.

What is claimed is:

1. A parking brake control system for selectively engaging/disengaging a vehicle parking brake, said control system being disposed adjacent a vehicle instrument panel, comprising:
a brake release handle, wherein the brake release handle is flush with the instrument panel when the parking brake is disengaged and wherein the brake release handle projects from the instrument panel when the parking brake is engaged; and
a brake pedal, wherein depressing the brake pedal simultaneously engages the parking brake and causes the brake release handle to project from the instrument panel.

2. The system of claim 1, wherein the brake release handle is supported on a lower portion of the instrument panel.

3. The system of claim 1, wherein the instrument panel has a curved front surface with a first degree of curvature and the release handle has a front face with a second degree of curvature, wherein the first degree of curvature is the same as the second degree of curvature.

4. The system of claim 1, wherein the release handle has sides that are visible when the parking brake is engaged.

5. The system of claim 1, wherein the release handle is initially extended from the instrument panel by depressing the brake pedal to engage the parking brake and wherein, to disengage the parking brake, the release handle is first further extended from the instrument panel and then released.

6. A method for operating a control system for a parking brake, said control system including a brake pedal and a brake release handle, wherein said pedal and handle are operably connected to one another and to the parking brake, said brake release handle being movably disposed in a vehicle instrument panel, comprising the step of:
depressing the brake pedal and thereby simultaneously causing the release handle to extend from the instrument panel and engage the parking brake.

7. A method for operating a control system of claim 6, comprising the further steps of:
disengaging the parking brake by:
pulling the brake release handle farther out of the instrument panel, and
letting the brake release handle return to the position flush with the instrument panel, thereby simultaneously returning the pedal to an undepressed position and disengaging the parking brake.
